(19) United States
(12) Patent Application Publication
(10) Pub. No.: US 2015/0381857 A1
(43) Pub. Date: Dec. 31, 2015

(54) GoPro Aiming Laser

(71) Applicant: John Daly, Fargo, ND (US)

(72) Inventor: John Daly, Fargo, ND (US)

(21) Appl. No.: 14/320,495

(22) Filed: Jun. 30, 2014

(51) Int. Cl. H04N 5/222; H04N 5/225

(52) U.S. Cl. CPC H04N 5/2228; H04N 5/2256

(57) ABSTRACT

This device employs a visible laser module that will typically be a laser diode with an output beam mechanically aligned to the GoPro camera lens and its FOV (Field of View). This device is small and lightweight and can either be built into any part of the GoPro assembly or can be attached to part of the camera assembly. The housing includes the laser module, On/Off switch, batteries, tilt switch, and the required electrical interconnections.

### FIELD OF THE INVENTION

The GroPro (and similar) compact cameras are used to record sporting (and other) activities. The pointing or aiming of the camera is often not known and cannot be verified by the user. By adding a small visible laser device with a switch, the user can confirm the mounted geometry is properly aligned. This accessory can be attached or built into the waterproof cover of the GoPro cameras used to mount these devices, or attached directly to the camera.

### BACKGROUND

GoPro cameras are used to film/record many activities. GoPro cameras are small, rugged, waterproof and come with many mounting geometries. Common mounting schemes include: helmets, race-cars, motorcycles, bicycles, boats, etc. It is common for the camera to be mounted in a way where you cannot see the camera (such as the helmet mounts) where pointing/alignment are not precise. The guessing method is then used to aim the camera in the right direction which might be different from what the user thinks he or she is aiming at. This is more problematic when the camera shifts during use.

GoPro cameras have a LCD screen that can attach to the back of the camera that aids in aiming the camera. This device is helpful in only mounts where the users are able to accesses and view the camera. The LCD screen is not practical for mounts such as the helmet mount or chest mount where it is difficult to see the camera or the back of the camera. The LCD screen also draws energy from the GoPro cameras battery limiting the amount of record time.

GoPro video cameras are used for sports and action and do not normally include a viewfinder. They are often employed in remote locations where the initial alignment must be verified. The laser beam is a quick and easier method for the user to adjust and lock the camera alignment or to verify its alignment later.

### SUMMARY OF THE INVENTION

The availability and low cost of laser diodes makes this device a practical solution to confirm aiming/alignment of the GoPro camera. The laser diode can be any visible wavelength. The red (630-670 nm) used for barcode scanners are very common. Other visible wavelengths are also available. In addition, the green (532-nm) diode pumped Nd: YAG-SHG laser pointers can be used. It is recommended that the laser selected be classified as eye safe, such as Class IIIa or 1M laser pointers. All these laser diode devices operate at low power with typical voltages of 3 VDC. This makes it easy to power them with common batteries. Suggested devices can utilize AA, AAA, N, LR44, CR2032, or any compatible battery. An On/Off switch will be included and can be a momentary switch with an external button or any single-pole switching device.

The proposed package is small to minimize weight and to fit into the common GoPro geometry. The waterproof cover is the most common accessory used for mounting and its back panel can be modified to include this device. The laser diode module, the switch, and batteries can be molded into this cover to minimize the added weight and volume of this device. The battery selection, such as CR2032 or LR44 also complements this smaller footprint. A similar but functionally identical package would allow the user to attach this device with adhesive tape or Velcro to the back of the existing cover back panel.

The design must include the laser normal (perpendicular) to the camera cover back panel and pointing in the same direction as the FOV (Field of View) of the camera. This can be determined with adequate precision by mechanical tolerances. Location of the laser is shown to one side of the camera lens. It can however, be located on either side or above/below the lens. The laser can also be attached directly to the camera or the mounting device and function in the same manner.

### BRIEF DESCRIPTION OF THE DRAWINGS

FIG. 1 shows the existing GoPro cover modified to include this device. This view from the inside shows the laser on the side. The laser assembly is shown here. The laser module and its output beam are aligned to be parallel to camera FOV when the cover is attached to the waterproof case with the camera installed. The laser and backdoor are built as one unit in this figure.

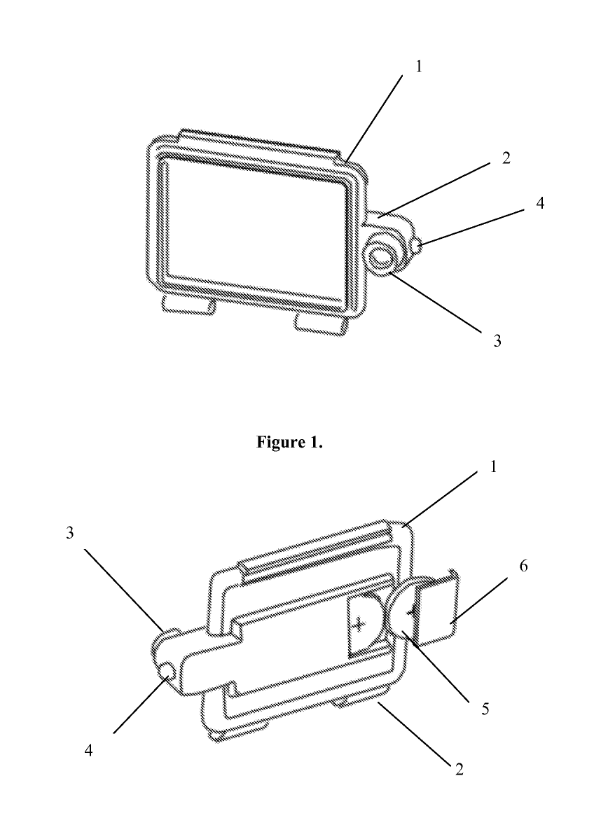

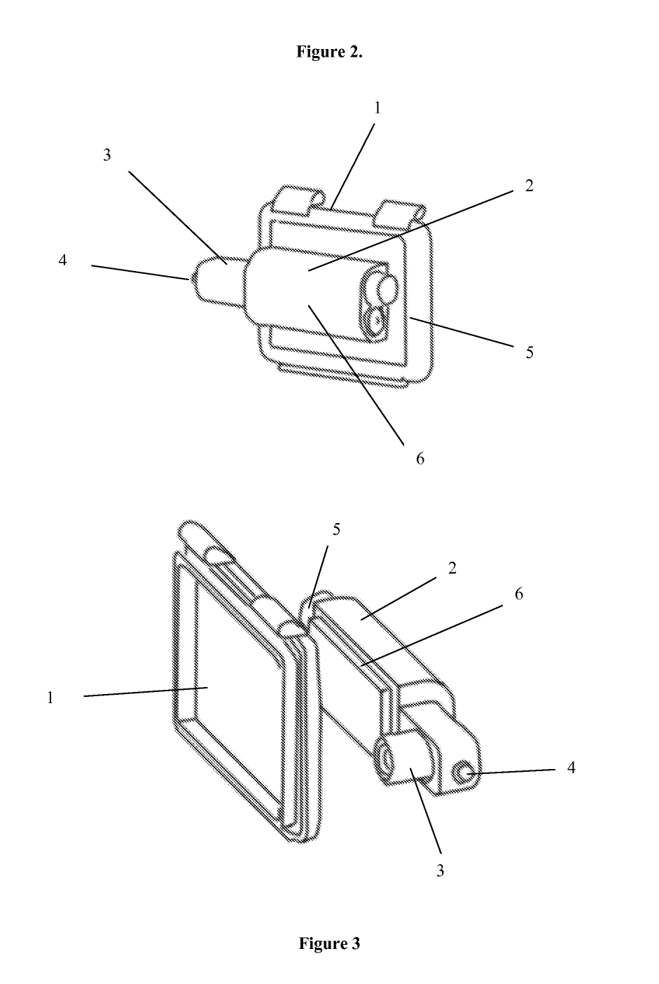

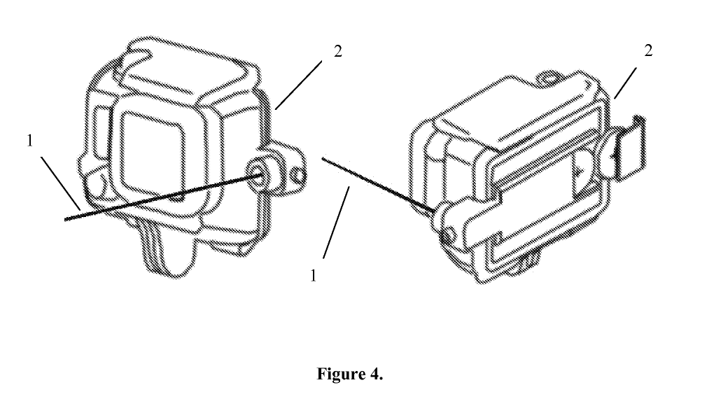

FIG. 2 is the same device shown from the back side. The following components are included in these figures.
1 GoPro waterproof back cover
3 Material added to back cover mold
4 Laser diode module
5 On/Off switch
6 Batteries, e.g. CR2032
7 Battery access cover

FIG. 3 shows a version that is functionally identical. It is however packaged as an accessory that can be attached (via adhesive) to the existing GoPro back cover. This package also shows the use of optional larger batteries. In this case, AAA batteries are shown. The adhesive can be double sided tape commonly used by GoPro for other accessories or any adhesive the user employs. The following components are included:
1. GoPro waterproof back cover
2. Molded housing for this device
3. Laser diode module
4. On/Off switch
5. 2× AAA batteries
6. Adhesive

FIG. 4 shows the Laser system attached to the actual GoPro camera. The modified case fits the GoPro housing as the original case would. The red laser points to the general location of the FOV. The assembly shown in FIG. 3 would fit on the GoPro housing same as this one shown here.
1. Red laser
2. Laser assembly attached to the GoPro housing.

### DETAILED DESCRIPTION AND BEST MODE OF IMPLEMENTATION

The basis of the GoPro laser is a diode laser powered by batteries. The whole laser assembly can be either built into the backdoor of a GoPro case or it can be made so it attaches to the backdoor or the case. The backdoor fits all cameras so the laser is universal for all GoPro cameras. The laser runs parallel with the lenses of the camera for accurate aiming. The whole assembly is built to be completely water proof and to endure the rugger during use. It is designed to fit the backdoor where it won't interfere with other mounts or during use, but to be still easily located. The laser can be powered by any battery that meets its requirements to use it. The battery pack is located on the backdoor where it will be out of the way. The laser wraps around to the side of the camera for accurate aiming. Batteries will be fully incased and waterproof. A door with a rubber gasket will allow for ease of accesses to batteries and optimal water protection. The momentary switch will be a rubber boot to ensure a tight water seal. The laser can also be equipped with a tilt sensor. The tilt sensor would disable the power so that the switch would not activate the laser when it is aimed well above the horizon as a safety device. Even though these lasers are classified as eye safe to prevent damage from the laser beam, they are very bright and can be a nuisance to others. The intend is for the user to only activate the laser in a safe and controlled mode during initial setup and for periodic verifications that the device is still aimed properly.

1. An aiming laser device is mounted to the GoPro (or similar) camera as a permanent or temporary to aid in confirming the pointing or aiming of the camera, compromising some combination of the following constituents:
A diode laser;
A molded case;
A switch;
An adhesive pad;
A battery housing;
A tilt sensor;

1. The aiming laser device in claim 1 wherein can be built into a modified camera back lid cover.

2. The diode laser in claim 1 wherein the laser beam is any visible wavelength, common/compact low cost available laser diodes are 670, 650, 633, 532, 514, 520 nm, and any other visible beam can be used.

3. The battery housing in claim 1 wherein the batteries can be housed inside the assembly and can be any common size or type required powering the laser.

4. The switch in claim 1 wherein the on switch for the laser can be a momentary switch or can be an on/off switch to allow quick and temporary alignment confirmation and to avoid nuisance problems with laser beam emissions and/or unwanted video capture including the laser beam.

5. The aiming laser device in clam 1 wherein is designed to be sealed as a rugged and weatherproof package.

6. The aiming laser device in claim 1 wherein the design can be modified to mate to any “old or new” version of the GoPro back lid or waterproof cover or assembly, or other similar device.

7. The laser aiming device in claim 1 wherein the laser device and package will be lightweight and will mount to the video camera with adhesive tape or Velcro to a mechanical datum on the camera referenced to correct alignment to the center of the FOV, or is a build-in device that becomes part of the video camera assemble such as the back plate cover.

8. The laser aiming device in claim 1 wherein the laser beam is not focused but collimated output to generate a beam that strikes the intended target of the video camera making the scattered/reflected beam spot that represents the center of the camera FOV that is registered to a mechanical datum of the camera body.

9. The aiming laser device in claim 1 wherein the operator can verify this alignment by viewing through the camera and activating the visible laser beam to confirm this alignment, in general the operator can simply momentarily activate the laser to confirm proper alignment of the camera FOV.

10. The aiming laser device in claim 1 wherein the laser device and mount are not adjustable.

11. The aiming laser device in claim 1 wherein the mechanical constraints include a mounting reference for the laser beam to be within the center of the video camera FOV.

12. The tilt sensor in claim 1 wherein the sensor will disable the switch when pointed well above the horizon to eliminate potential nuisance laser beam emissions.
